(19) United States
(12) Patent Application Publication
(10) Pub. No.: US 2026/0269847 A1
(43) Pub. Date: Sep. 10, 2026

(54) TIME DIVISION DUPLEXING FOR SPECTRUM CONFIGURED FOR FREQUENCY DIVISION DUPLEXING

(71) Applicant: QUALCOMM Incorporated, San Diego, CA (US)

(72) Inventors: Yi HUANG, San Diego, CA (US); Jing JIANG, San Diego, CA (US); Jing SUN, San Diego, CA (US)

(21) Appl. No.: 19/069,735

(22) Filed: Mar. 4, 2025

(51) Int. Cl. H04B 1/00; H04B 17/354; H04L 5/14; H04W 72/1263

(52) U.S. Cl. CPC H04B 1/005; H04B 17/354; H04L 5/14; H04W 72/1263

(57) ABSTRACT

Various aspects of the present disclosure generally relate to wireless communication. In some aspects, a user equipment (UE) may receive, from a network node, a configuration indicating a time division duplexing (TDD) pattern associated with a spectrum configured for frequency division duplexing (FDD), wherein the TDD pattern includes one or more uplink slots and one or more downlink slots. In some aspects, the spectrum may be a downlink spectrum configured for FDD or an uplink spectrum configured for FDD. The UE may communicate with the network node in the spectrum configured for FDD according to the TDD pattern and according to one or more adjacent channel leakage ratio (ACLR) parameters. In some aspects, a message that schedules a transmissions may indicate whether the transmission is to be performed via the uplink spectrum or the downlink spectrum. Numerous other aspects are described.

### FIELD OF THE DISCLOSURE

Aspects of the present disclosure generally relate to wireless communication and specifically relate to techniques, apparatuses, and methods associated with time division duplexing for spectrum configured for frequency division duplexing.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some examples, a wireless communication system may be configured to support frequency division duplexing (FDD) techniques. For example, the wireless communication system may configure a spectrum for FDD, and the spectrum may include a first frequency region (or channel) configured for uplink communications (e.g., transmitted from a user equipment (UE) to a network node) and a second frequency region (or channel) configured for downlink communication (e.g., transmitted from the network node to one or more UEs). In some cases, the frequency regions or channels used for uplink communication and downlink communication do not overlap, have different center frequencies, and have sufficient separation to prevent interference between the downlink communication and the uplink communication. In some examples, the frequency regions or channels may be further divided into bandwidths for different cells (e.g., carriers) of the wireless communication system. For example, the first frequency region may include multiple uplink bandwidths corresponding to multiple cells, and the second frequency region may include multiple downlink bandwidths corresponding to the multiple cells.

In some examples, a wireless communication system may be configured to support time division duplexing (TDD) techniques. For example, the wireless communication system may configure a spectrum for TDD, which may include a set of slots spread in the time domain. In some cases, a first subset of the set of slots may be configured for uplink communications, and a second subset of the set of slots may be configured for downlink communications.

### SUMMARY

Some aspects described herein relate to a user equipment (UE) for wireless communication. The UE may include a processing system that includes one or more processors and one or more code-storing memories. The processing system may be configured to cause the UE to receive, from a network node, a configuration indicating a time division duplexing (TDD) pattern associated with a spectrum configured for frequency division duplexing (FDD), wherein the TDD pattern includes one or more uplink slots and one or more downlink slots. The one or more processors may be configured to cause the UE to communicate with the network node in the spectrum configured for FDD according to the TDD pattern and according to one or more adjacent channel leakage ratio (ACLR) parameters.

Some aspects described herein relate to a network node for wireless communication. The network node may include a processing system that includes one or more processors and one or more code-storing memories. The processing system may be configured to cause the network node to transmit, to a UE, a configuration indicating a TDD pattern associated with a spectrum configured for FDD, wherein the TDD pattern includes one or more uplink slots and one or more downlink slots. The one or more processors may be configured to cause the network node to communicate with the UE in the spectrum configured for FDD according to the TDD pattern and according to one or more ACLR parameters.

Some aspects described herein relate to a method of wireless communication performed by a UE. The method may include receiving, from a network node, a configuration indicating a TDD pattern associated with a spectrum configured for FDD, wherein the TDD pattern includes one or more uplink slots and one or more downlink slots. The method may include communicating with the network node in the spectrum configured for FDD according to the TDD pattern and according to one or more ACLR parameters.

Some aspects described herein relate to a method of wireless communication performed by a network node. The method may include transmitting, to a UE, a configuration indicating a TDD pattern associated with a spectrum configured for FDD, wherein the TDD pattern includes one or more uplink slots and one or more downlink slots. The method may include communicating with the UE in the spectrum configured for FDD according to the TDD pattern and according to one or more ACLR parameters.

Some aspects described herein relate to a non-transitory computer-readable medium that stores a set of instructions for wireless communication by a UE. The set of instructions, when executed by one or more processors of the UE, may cause the UE to receive, from a network node, a configuration indicating a TDD pattern associated with a spectrum configured for FDD, wherein the TDD pattern includes one or more uplink slots and one or more downlink slots. The set of instructions, when executed by one or more processors of the UE, may cause the UE to communicate with the network node in the spectrum configured for FDD according to the TDD pattern and according to one or more ACLR parameters.

Some aspects described herein relate to a non-transitory computer-readable medium that stores a set of instructions for wireless communication by a network node. The set of instructions, when executed by one or more processors of the network node, may cause the network node to transmit, to a UE, a configuration indicating a TDD pattern associated with a spectrum configured for FDD, wherein the TDD pattern includes one or more uplink slots and one or more downlink slots. The set of instructions, when executed by one or more processors of the network node, may cause the network node to communicate with the UE in the spectrum configured for FDD according to the TDD pattern and according to one or more ACLR parameters.

Some aspects described herein relate to an apparatus for wireless communication. The apparatus may include means for receiving, from a network node, a configuration indicating a TDD pattern associated with a spectrum configured for

FDD, wherein the TDD pattern includes one or more uplink slots and one or more downlink slots. The apparatus may include means for communicating with the network node in the spectrum configured for FDD according to the TDD pattern and according to one or more ACLR parameters.

Some aspects described herein relate to an apparatus for wireless communication. The apparatus may include means for transmitting, to a UE, a configuration indicating a TDD pattern associated with a spectrum configured for FDD, wherein the TDD pattern includes one or more uplink slots and one or more downlink slots. The apparatus may include means for communicating with the UE in the spectrum configured for FDD according to the TDD pattern and according to one or more ACLR parameters.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating examples of different duplexing modes.

FIG. 4 is a diagram illustrating examples of spectrums configured for frequency division duplexing (FDD).

FIG. 5 is a diagram illustrating examples of time division duplexing (TDD) for spectrums configured for FDD.

FIG. 6 is a diagram illustrating an example of restrictions for TDD for spectrums configured for FDD.

FIG. 7 is a diagram illustrating an example of restrictions for TDD for spectrums configured for FDD.

FIG. 8 is a diagram illustrating an example that supports configuring TDD for an FDD spectrum.

FIG. 9 is a diagram illustrating an example process performed, for example, at a user equipment (UE) or an apparatus of a UE.

FIG. 10 is a diagram illustrating an example process performed, for example, at a network node or an apparatus of a network node.

FIG. 11 is a diagram of an example apparatus for wireless communication.

FIG. 12 is a diagram of an example apparatus for wireless communication.

### DETAILED DESCRIPTION

In some examples, a wireless communication system may be configured to support frequency division duplexing (FDD) techniques. For example, the wireless communication system may configure a bandwidth for FDD, such that the bandwidth includes a first frequency band (e.g., a channel) configured for uplink communications and a second frequency band configured for downlink communications. Uplink communications may refer to communications transmitted from a user equipment (UE) to a network node, and downlink communications may refer to communications transmitted from a network node to a UE. In some examples, the frequency bands may be further divided and configured for use by different cells of the wireless communication system. For example, a first cell (for example, or a carrier or operator) may be associated with an uplink spectrum that is a portion of the first frequency band configured for uplink communications, and a downlink spectrum that is portion of the second frequency region configured for downlink communications. In some cases, each portion may be a same size. For example, the single cell may be configured for operations within a 20 megahertz (MHz) spectrum of the first frequency region for uplink communications and a 20 MHz spectrum of the second frequency region for downlink communications, among other examples.

In some cases, an amount of uplink traffic (e.g., an amount of uplink communications scheduled or transmitted) and an amount of downlink traffic (e.g., an amount of downlink communications scheduled or transmitted) for a cell may vary depending on channel conditions, and the uplink traffic and downlink traffic may be asymmetric. For example, downlink traffic may be heavier than uplink traffic for a cell, as UEs may request larger amounts of downlink data (e.g., video or music streaming, or file downloads associated with large file sizes) than the uplink data transmitted by UEs (e.g., text or voice calls associated with small file sizes). In some other examples, uplink traffic associated with the cell may be heavier than downlink traffic, such as when the cell supports operations that include uplink-heavy data transmissions (e.g., video surveillance or upload, large data size uploading, or other operations that may involve large uplink data transmissions).

In some cases, the uplink traffic and the downlink traffic being asymmetric may result in an underutilization of an FDD uplink spectrum or an FDD downlink spectrum for the cell. For example, in cases where downlink traffic is larger than uplink traffic, the FDD downlink spectrum may be saturated (e.g., downlink transmissions are scheduled for all or a large amount of slots of the downlink spectrum) while the FDD uplink spectrum is underutilized (e.g., one or more slots of the uplink spectrum are not used for transmissions). Alternatively, in cases where uplink traffic is heavier than uplink traffic, the FDD uplink spectrum may be saturated (e.g., uplink transmissions are scheduled for all or a large amount of slots of the uplink spectrum) while the FDD downlink spectrum is underutilized (e.g., one or more slots of the downlink spectrum are not used for transmissions). Accordingly, if the saturated FDD spectrum does not support traffic associated with the cell, communications via the FDD saturated spectrum may be delayed to accommodate the traffic. Additionally, or alternatively, a throughput for communications associated with the cell may be limited, as the cell is not configured to utilize the unused portions of the non-saturated FDD spectrum to support the traffic.

Various aspects relate generally to supporting time division duplexing (TDD) for spectrums configured for FDD. Some aspects more specifically relate to mitigating leakage to adjacent frequency bands when supporting TDD for spectrums configured for FDD. In a spectrum (e.g., a band or channel) configured for FDD and TDD, the spectrum may support both uplink communications and downlink communications at different times and via different frequencies. For example, an uplink spectrum configured for uplink transmissions associated with a cell may be configured with a TDD pattern that includes one or more downlink slots in addition to one or more uplink slots. Additionally, or alternatively, a downlink spectrum configured for downlink transmissions associated with the cell may be configured with a TDD pattern that includes one or more uplink slots in addition to one or more downlink slots.

In some aspects, uplink communications transmitted via the downlink spectrum or downlink messages transmitted via the uplink spectrum may be subject to one or more constraints (e.g., restrictions) to limit leakage to adjacent frequency bandwidths. For example, a network node or a UE may be configured with one or more adjacent channel leakage ratio (ACLR) parameters that may be used for transmissions via the uplink spectrum or the downlink spectrum. In some aspects, downlink messages transmitted via the uplink spectrum may be limited in power, or the downlink messages may be transmitted via at least one resource block (RB) at the center of the uplink spectrum while one or more RBs located at one or more edges (e.g., an upper edge or a lower edge)of the uplink spectrum may be restricted from being used for downlink transmissions. Additionally, or alternatively, a TDD pattern may include one or more special slots, which may include a downlink portion, a guard portion, and an uplink portion, where transmissions may be restricted during the guard portion.

Particular aspects of the subject matter described in this disclosure can be implemented to realize one or more of the following potential advantages. In some examples, the described techniques may support transmission of uplink communications by a UE via the downlink spectrum in accordance with the TDD pattern. Additionally, or alternatively, the described techniques may support transmission of downlink communications by a network node via the uplink spectrum in accordance with the TDD pattern. Accordingly, the described techniques may support improved utilization of network resources relative to FDD-only spectrums, as the downlink spectrum may be used for uplink transmissions in cases where uplink traffic is heavy, while the uplink spectrum may be used for downlink transmissions in cases where downlink traffic is heavy. Additionally, by configuring one or more restrictions for uplink transmissions via the downlink spectrum, or for downlink transmissions via the uplink spectrum, the described techniques may mitigate interference to devices operating in adjacent frequency regions. For example, leakage to adjacent frequency bandwidths may be mitigated by reducing a transmission power of downlink transmissions transmitted via the uplink spectrum, or by limiting the downlink transmissions to center RBs of the uplink spectrum. Additionally, or alternatively, by configuring a guard portion during a special slot, the described techniques may mitigate interference to adjacent frequency bandwidths that may be caused by desynchronization between spectrums using the same TDD pattern.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

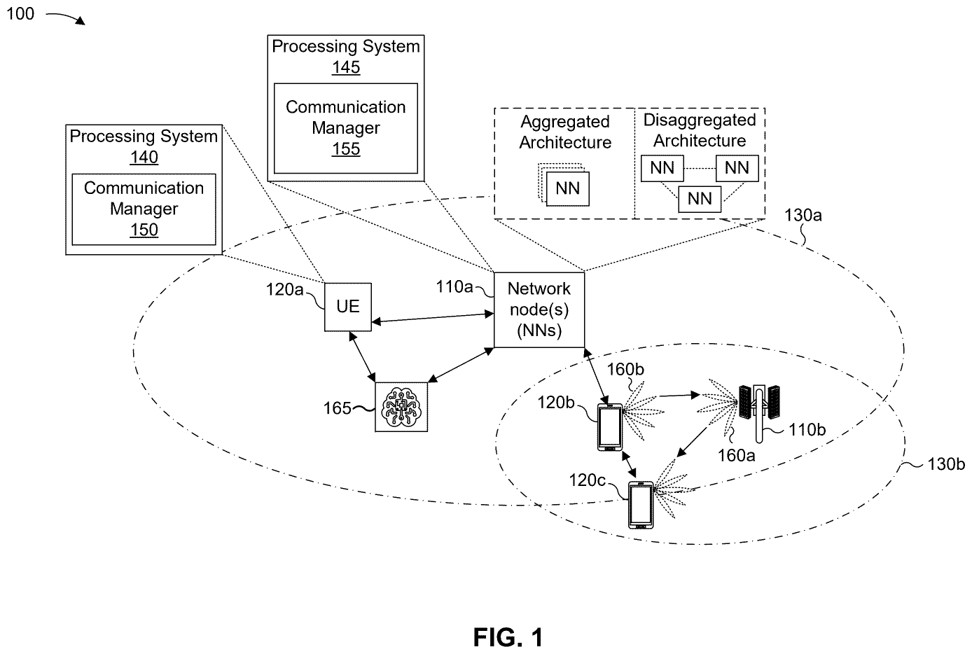

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR 1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an

IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive, from a network node 110, a configuration indicating a TDD pattern associated with a spectrum configured for FDD, wherein the TDD pattern includes one or more uplink slots and one or more downlink slots; and communicate with the network node 110 in the spectrum configured for FDD according to the TDD pattern and according to one or more ACLR parameters. Additionally, or alternatively, the communication manager 150 may perform one or more other operations described herein.

In some aspects, the network node 110 may include a communication manager 155. As described in more detail elsewhere herein, the communication manager 155 may transmit, to a UE 120, a configuration indicating a TDD pattern associated with a spectrum configured for FDD, wherein the TDD pattern includes one or more uplink slots and one or more downlink slots; and communicate with the UE 120 in the spectrum configured for FDD according to the TDD pattern and according to one or more ACLR parameters. Additionally, or alternatively, the communication manager 155 may perform one or more other operations described herein.

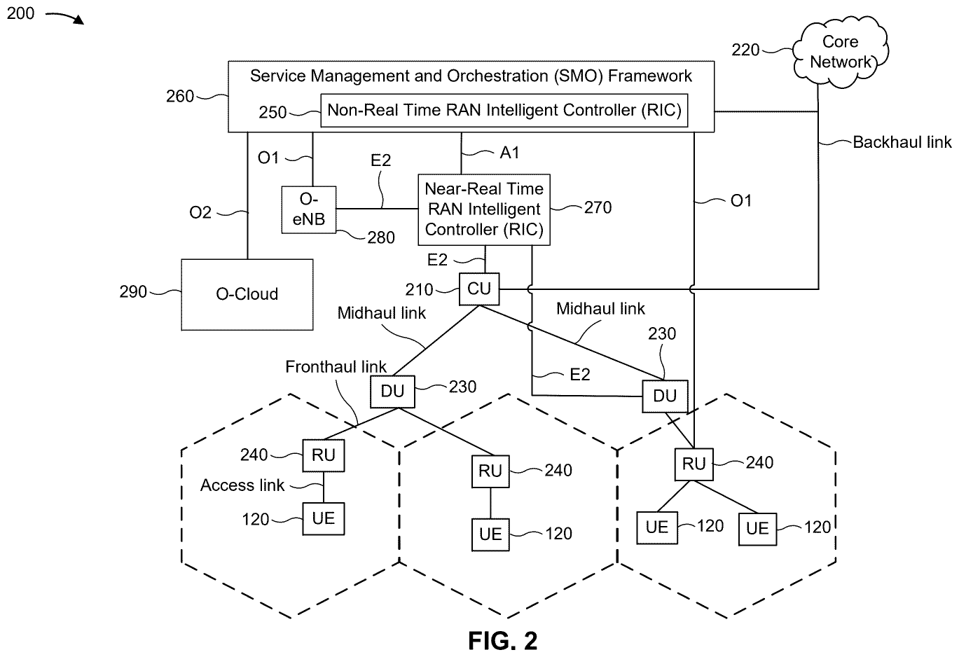

FIG. 2 is a diagram illustrating an example disaggregated network node architecture 200. One or more components of the example disaggregated network node architecture 200 may be, may include, or may be included in one or more network nodes (such as one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

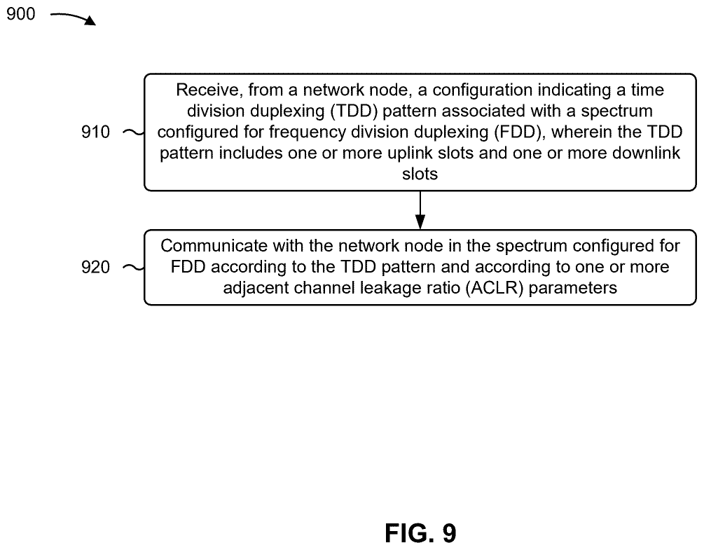

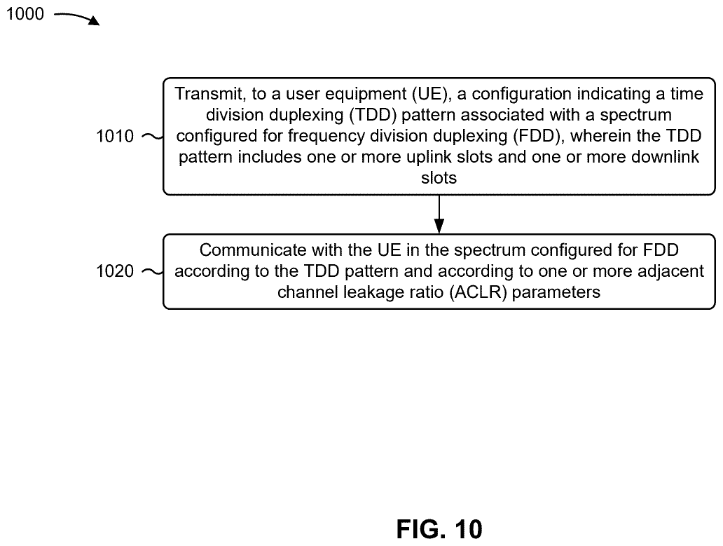

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with TDD for spectrums configured for FDD, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, or interpreting the instructions, among other examples.

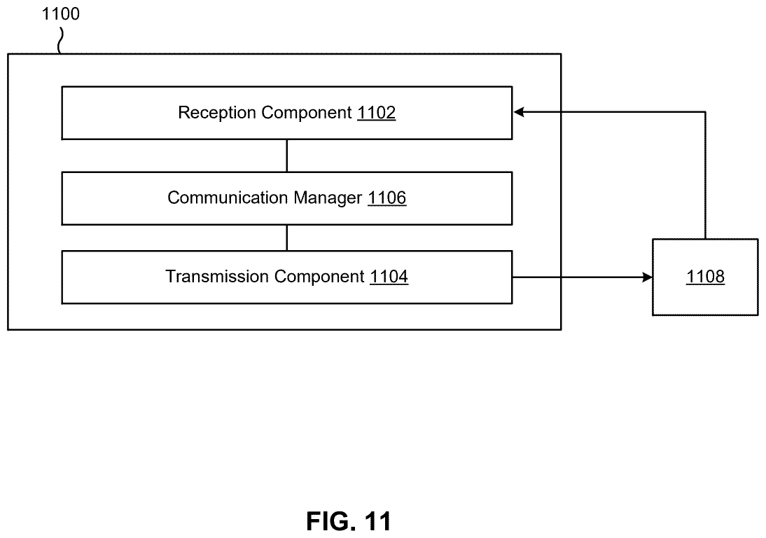

In some aspects, the UE 120 includes means for receiving, from a network node 110, a configuration indicating a TDD pattern associated with a spectrum configured for FDD, wherein the TDD pattern includes one or more uplink slots and one or more downlink slots; and/or means for communicating with the network node 110 in the spectrum configured for FDD according to the TDD pattern and according to one or more ACLR parameters. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

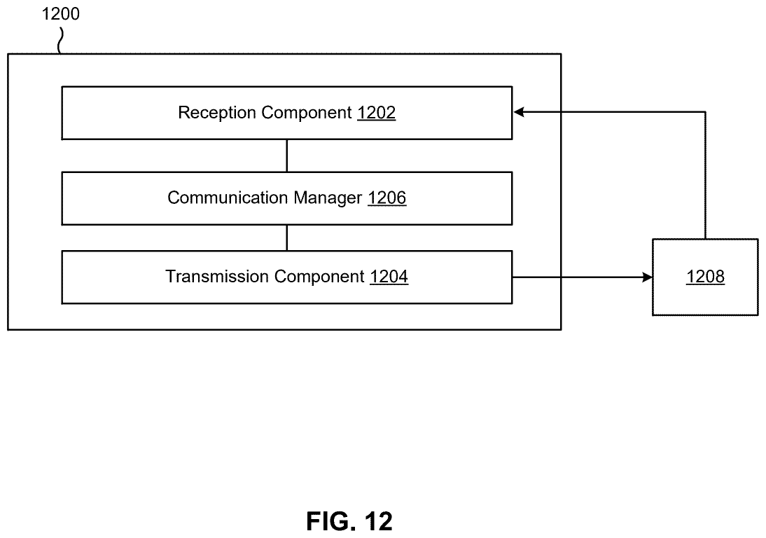

In some aspects, the network node 110 includes means for transmitting, to a UE 120, a configuration indicating a TDD pattern associated with a spectrum configured for FDD, wherein the TDD pattern includes one or more uplink slots and one or more downlink slots; and/or means for communicating with the UE 120 in the spectrum configured for FDD according to the TDD pattern and according to one or more ACLR parameters. The means for the network node 110 to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

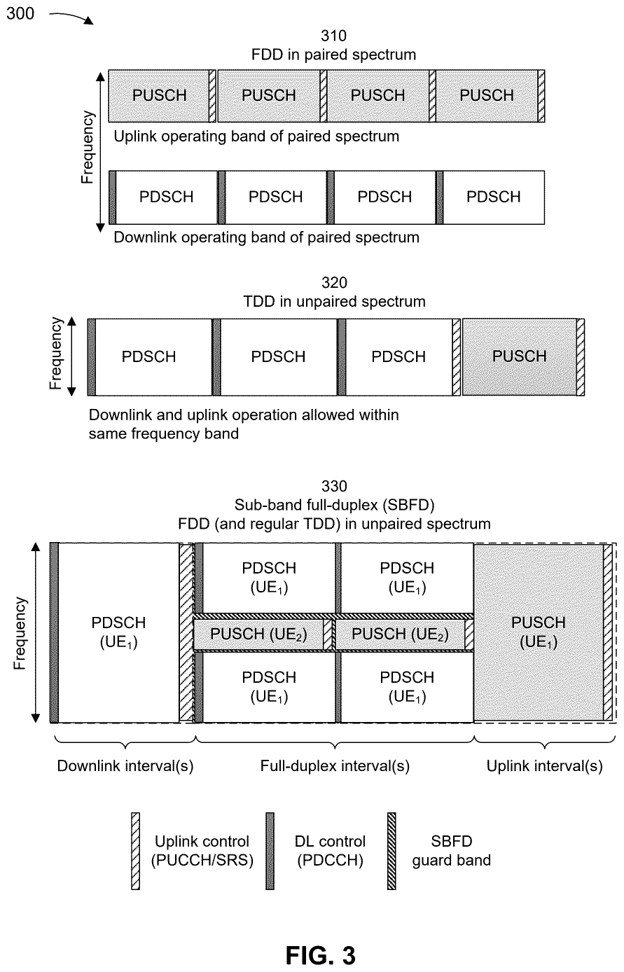

FIG. 3 is a diagram illustrating examples 300 of different duplexing modes. For example, as described in further detail herein, FIG. 3 illustrates an example 310 of an FDD mode that may be used in paired spectrum, an example 320 of a TDD mode that may be used in unpaired spectrum, and an example 330 of an SBFD mode that may be used in unpaired spectrum.

In some aspects, a wireless communication standard and/or governing body may generally specify one or more duplexing modes in which a wireless spectrum is to be used. For example, 3GPP may specify how wireless spectrum is to be used for the 5G/NR radio access technology and interface. As an example, a specification may indicate whether a band is to be used as paired spectrum in an FDD mode or as unpaired spectrum in a TDD mode.

For example, as shown by example 310, paired spectrum in the FDD mode may use a first frequency region (or channel) for uplink communication and a second frequency region (or channel) for downlink communication. In such cases, the frequency regions or channels used for uplink communication and downlink communication do not overlap, have different center frequencies, and have sufficient separation to prevent interference between the downlink communication and the uplink communication. For example, paired spectrum in FDD mode may include an uplink operating band and a downlink operating band that are configured to use non-overlapped frequency regions separated by a guard band. Accordingly, when operating in the FDD mode as paired spectrum, a network node or a UE with full-duplex capabilities may perform concurrent transmit and receive operations using the separate operating bands allocated to downlink and uplink communication. For example, paired bands in NR include NR operating bands n1, n2, n3, n5, n7, n8, n12, n20, n25, and n28, as specified by 3GPP Technical Specification (TS) 38.101-1.

Alternatively, as shown by example 320, unpaired spectrum in the TDD mode may allow downlink and uplink operation within a single frequency region (e.g., a single operating band). For example, when operating in TDD mode using unpaired spectrum, downlink communication and uplink communication may occur in the same frequency range. Some deployments may use TDD in the unpaired band, whereby some transmission time intervals (e.g., frames, slots, and/or symbols) are used for downlink communication only and other transmission time intervals are used for uplink communication only. In this case, substantially the entire bandwidth of a component carrier may be used for downlink communication or uplink communication, depending on whether the communication is performed in a downlink interval, an uplink interval, or a special interval (in which either downlink or uplink communication can be scheduled). Examples of unpaired bands include NR operating bands n40, n41, and n50, as specified by 3GPP TS 38.101-1.

As shown by example 330, unpaired band may be configured in a full-duplexing mode to enable concurrent transmit and receive operations in unpaired spectrum (e.g., a TDD band). For example, in FIG. 3, example 330 depicts an SBFD mode, which may be referred to herein as full-duplexing in a frequency division multiplexing (FDM) mode or using other suitable terminology, in order to enable TDD operation and/or FDD operation in unpaired spectrum. For example, as shown in FIG. 3, unpaired band configured in the SBFD mode may associate one or more transmission time intervals with downlink communication only (e.g., “D” slots), one or more transmission time intervals for uplink communication only (e.g., “U” slots), and one or more transmission time intervals for both downlink communication and uplink communication (e.g., “D+U” slots). Each transmission time interval may be associated with a control region, illustrated as a portion of a time interval with a diagonal fill for uplink control (e.g., a PUCCH) or a darker-shaded fill for downlink control (e.g., a PDCCH). Additionally, or alternatively, each time interval may be associated with a data region, which is shown as a PDSCH for downlink frequency regions or a PUSCH for uplink frequency regions.

In some aspects, unpaired band configured in the SBFD mode may include one or more downlink-only time intervals, one or more uplink-only time intervals, and/or one or more full-duplex time intervals (e.g., frames, subframes, slots, and/or symbols, among other examples) that are associated with an FDD configuration. For example, as shown in FIG. 3, the FDD configuration associated with a full-duplex time interval may indicate one or more downlink frequency regions (or sub-bands) and one or more uplink frequency regions (or sub-bands) that are separated by a guard band. Accordingly, an FDD configuration may divide unpaired frequency band (e.g., one or more component carriers of an unpaired band) into uplink frequency regions, downlink frequency regions, and/or other regions (e.g., guard bands and/or the like), which may enable a network node or a UE with full-duplex capabilities to perform simultaneous transmit and receive operations during one or more time intervals that are divided into downlink and uplink sub-bands with a guard band separation to prevent the uplink transmission from causing self-interference with respect to downlink reception. For example, in a given full-duplex time interval, a half-duplexing UE may either transmit using the uplink frequency region or receive in the downlink frequency region (e.g., a UE communicating in a half-duplexing mode may only receive in a downlink frequency region or transmit in an uplink frequency region during the full-duplex time intervals). Alternatively, a full-duplexing UE may transmit using the uplink frequency region and/or receive in the downlink frequency region. Additionally, or alternatively, a full-duplexing network node may transmit a downlink communication to a first UE within the downlink frequency regions(s) and simultaneously receive an uplink communication from a second UE in the uplink frequency region(s).

In some aspects, the paired spectrum configured for FDD may be additionally configured to support TDD. For example, the uplink operating band of the paired spectrum and the downlink operating band of the paired spectrum may each be configured for both uplink transmissions (e.g., PUSCH) and downlink transmissions (e.g., PDSCH), as described in further detail herein. In some aspects, uplink communications transmitted via the downlink operating band or downlink communications transmitted via the uplink operating band may be subject to one or more constraints to limit leakage to adjacent frequency bands. For example, a network node 110 or a UE 120 may be configured with one or more ACLR parameters to limit leakage to adjacent frequency bandwidths. In some aspects, downlink messages transmitted via the uplink operating band may be limited in power, or the downlink messages may be transmitted via at least one RB positioned at the center of the uplink operating band while one or more RBs located at an edge of the uplink operating band may be restricted (e.g., not used for downlink transmissions). Additionally, or alternatively, the TDD pattern may include one or more special slots, which may include an uplink portion, a guard portion, and a downlink portion, where transmissions may be restricted during the guard portion.

As indicated above, FIG. 3 is provided as an example. Other examples may differ from what is described with regard to FIG. 3.

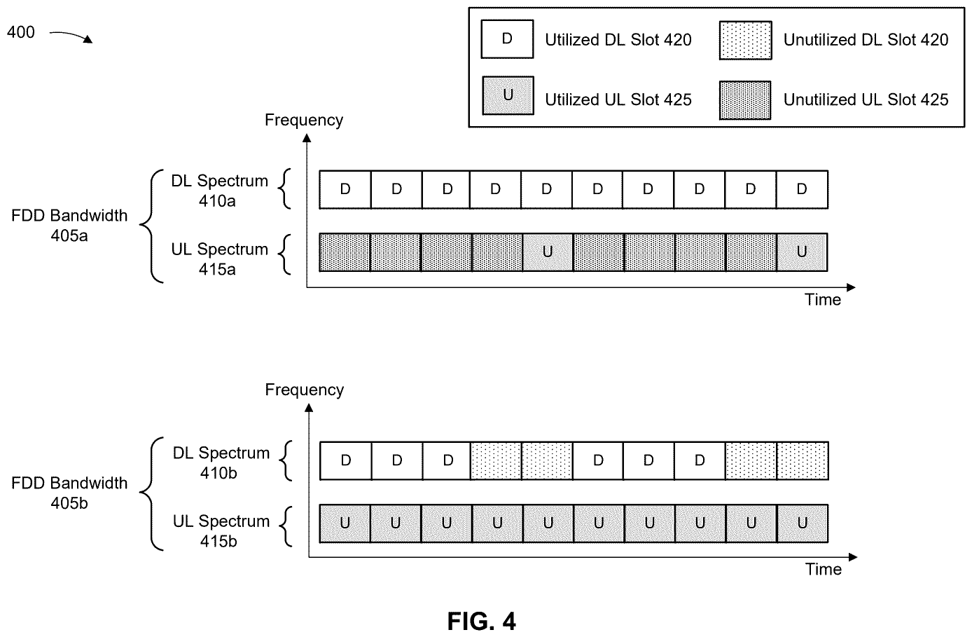

FIG. 4 is a diagram illustrating examples 400 of spectrums configured for FDD. For example, examples 400 illustrates an FDD bandwidth 405a and a FDD bandwidth 405b (e.g., bandwidths configured for FDD), which may be examples of a bandwidth (e.g., a carrier bandwidth) allocated for communications associated with a cell.

In some examples, the FDD bandwidth 405a may include a downlink spectrum 410a (depicted as a DL spectrum) configured for downlink transmissions via one or more downlink slots 420 (depicted as “D” slots) and an uplink spectrum 415a (depicted as a “UL” spectrum) configured for uplink transmissions via one or more uplink slots 425 (depicted as “U” slots). Similarly, the FDD bandwidth 405b may include a downlink spectrum 410b configured for downlink transmissions via one or more downlink slots 420 and an uplink spectrum 415b configured for uplink transmissions via one or more uplink slots 425.

In some cases, an amount of uplink traffic (e.g., an amount of uplink communications scheduled or transmitted) and an amount of downlink traffic (e.g., an amount of downlink communications scheduled or transmitted) for the cell may vary depending on channel conditions or operations of devices associated with the cell, and the uplink traffic and downlink traffic may be asymmetric. For example, as shown with reference to the FDD bandwidth 405a, downlink traffic may be heavier than uplink traffic, which may occur when a network node 110 is transmitting (for example, or scheduling) more downlink data to UEs 120 than the uplink data that is received (for example, or scheduled to be received) by the network node 110 from the UEs 120. Accordingly, the downlink spectrum 410a may be saturated, while the uplink spectrum 415a may be underutilized. For example, one or more of the uplink slots 425 of the uplink spectrum 415a may be unutilized and not used for transmissions associated with the cell. As described herein, a utilized slot may refer to a slot via which transmissions are performed or a slot for which transmissions are scheduled, while an unutilized slot may refer to a slot for which no transmissions are scheduled.

Alternatively, as shown with reference to the FDD bandwidth 405b, the uplink traffic may be larger than the downlink traffic, such as in cases where the network node 110 is receiving more uplink communications from the UEs 120 than the downlink communications that are transmitted by the network node 110 to the UEs 120. Accordingly, the uplink spectrum 415b may be saturated, while the downlink spectrum 410b may be underutilized. For example, one or more of the downlink slots 420 of the downlink spectrum 410b may be unutilized and not used for transmissions associated with the cell. Accordingly, the saturated spectrums may result in communication delays to accommodate the traffic. Additionally, or alternatively, a throughput for communications associated with the cell may be limited, as the cell is not configured to use the unutilized slots portions of the non-saturated spectrum in accordance with the asymmetric traffic.

In some aspects, TDD may be implemented for downlink spectrums 410 configured for FDD and/or uplink spectrums 415 configured for FDD. For example, as described in further detail herein, the uplink spectrum 415a may be additionally configured for downlink transmissions, which may enable the network node 110 to perform downlink transmissions via the uplink spectrum 415a in cases when the downlink traffic is larger than the uplink traffic. Additionally, or alternatively, the downlink spectrum 410b may be additionally configured for uplink transmissions, which may enable UEs 120 to perform uplink transmissions via the downlink spectrum 410b in cases when the uplink traffic is larger than the downlink traffic. Accordingly, a quantity of unutilized slots of the FDD bandwidth 405a and the FDD bandwidth 405b may be reduced, which may improve a throughput of communications associated with the cell, may reduce latency associated with transmissions via a saturated spectrum, and may improve spectral efficiency associated with the cell.

As indicated above, FIG. 4 is provided as an example. Other examples may differ from what is described with regard to FIG. 4.

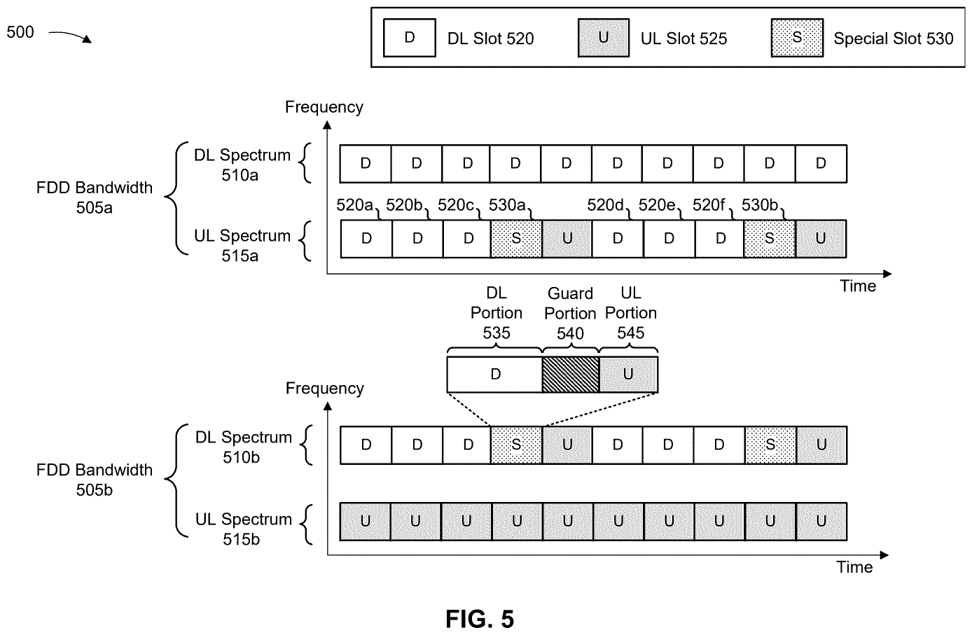

FIG. 5 is a diagram illustrating examples 500 of TDD for spectrums configured for FDD. For example, the examples 500 illustrate an FDD bandwidth 505a and an FDD bandwidth 505b, which may be examples of a bandwidth (e.g., a carrier bandwidth) allocated for communications associated with a cell. In some examples, the FDD bandwidth 505a and the FDD bandwidth 505b may be configured for communications between a network node 110 and a UE 120.

The FDD bandwidth 505a may include a downlink spectrum 510a and an uplink spectrum 515a. In some aspects, the uplink spectrum 515a may be configured to support TDD. For example, the uplink spectrum 515a may include one or more downlink slots 520, such as downlink slot 520a, 520b, 520c, 520d, 520e, and 520f, in addition to one or more uplink slots 525. Additionally, or alternatively, the uplink spectrum 515a may include one or more special slots 530, as described herein. In some examples, each special slot 525 may include a downlink portion 535, a guard portion 540, and an uplink portion 545. In some cases, the guard portion 540 may be positioned between the downlink portion 535 and the uplink portion 545.

In some aspects, the network node 110 may transmit a configuration indicating a TDD pattern for the uplink spectrum 515a, and the TDD pattern may indicate the one or more downlink slots 520, the one or more uplink slots 525, or the one or more special slots 530 for the uplink spectrum 515a. For example, the TDD pattern may be a “DDDSU” pattern, which may correspond to the pattern shown in the example 500. However, different TDD patterns may be used having a different quantity or a different order associated with the one or more downlink slots 520, the one or more uplink slots 525, or the one or more special slots 530. In some cases, a special slot 530 may be positioned between a downlink slot 520 and an uplink slot 525 (e.g., when the TDD pattern switches from downlink to uplink).

In some aspects, the network node 110 may transmit the TDD pattern for the uplink spectrum 515a based on channel conditions. For example, the network node 110 may transmit the TDD pattern for the uplink spectrum 515a in accordance with uplink traffic associated with the FDD bandwidth 505a being larger than downlink traffic associated with the FDD bandwidth 505a. Additionally, or alternatively, the network node 110 may transmit the TDD pattern for the uplink spectrum 515a in accordance with at least one of the uplink traffic satisfying a threshold (e.g., a first traffic threshold), or the downlink traffic failing to satisfy a threshold (e.g., the first traffic threshold, or a second traffic threshold).

The FDD bandwidth 505b may include a downlink spectrum 510b and an uplink spectrum 515b. In some aspects, the downlink spectrum 510b may be configured to support TDD. For example, the downlink spectrum 510b may include one or more uplink slots 525, in addition to one or more downlink slots 520. Additionally, or alternatively, the downlink spectrum 510b may include one or more special slots 525, as described herein. In some aspects, the network node 110 may transmit a configuration indicating a TDD pattern for the downlink spectrum 510b, and the TDD pattern may indicate the one or more downlink slots 520, the one or more uplink slots 525, or the one or more special slots 530 for the uplink spectrum 515a. For example, the TDD pattern may be the “DDDSU” pattern, which may correspond to the pattern shown in the example 500. However, different TDD patterns may be used having a different quantity or a different order associated with the one or more downlink slots 520, the one or more uplink slots 525, or the one or more special slots 530.

In some aspects, the network node 110 may transmit the TDD pattern for the downlink spectrum 510b based on channel conditions. For example, the network node 110 may transmit the TDD pattern for the downlink spectrum 510b in accordance with downlink traffic associated with the FDD bandwidth 505b being larger than uplink traffic associated with the FDD bandwidth 505b. Additionally, or alternatively, the network node 110 may transmit the TDD pattern for the uplink spectrum 515a in accordance with at least one of the downlink traffic satisfying a threshold (e.g., a first traffic threshold), or the uplink traffic failing to satisfy a threshold (e.g., the first traffic threshold, or a second traffic threshold).

Accordingly, the FDD bandwidth 505a may be configured to support TDD for the uplink spectrum 515a, which may enable the network node 110 to transmit downlink messages via the one or more downlink slots 520 of the uplink spectrum 515a (e.g., in cases where downlink traffic is heavy, or uplink traffic is light). Additionally, the FDD bandwidth 505b may be configured to support TDD for the downlink spectrum 510b, which may enable the UE 120 to transmit uplink messages via the one or more uplink slots 525 of the downlink spectrum 510b (e.g., in cases where downlink traffic is heavy, or downlink traffic is light).

In some aspects, the network node 110 may indicate, to the UE 120, whether to transmit uplink messages via the downlink spectrum 510b (e.g., via uplink slots 525 or special slots 530) or via the uplink spectrum 515b. In some examples, the network node 110 may transmit a scheduling message to the UE 120 scheduling the uplink messages, and the scheduling message may indicate whether to transmit the uplink messages via the downlink spectrum 510b or the uplink spectrum 515b. For example, the network node 110 may transmit a DCI message that schedules (e.g., dynamically schedules) a PDSCH message for transmission from the network node 110 to the UE 120 or a PUSCH message for transmission from the UE 120 to the network node 110. In some aspects, the DCI message may indicate (e.g., via at least one bit) whether the PDSCH message or the PUSCH message scheduled by the DCI message is to be transmitted via an uplink spectrum 515 or a downlink spectrum 510. Additionally, or alternatively, the network node 110 may transmit an RRC message that configures one or more PDSCH messages (e.g., for semi-persistent scheduling) or one or more PUSCH messages (e.g., for configured grant scheduling), and the RRC message may indicate (e.g., via at least one bit) whether the one or more PDSCH messages or the one or more PUSCH messages configured by the RRC message are to be transmitted via the uplink spectrum 515 or the downlink spectrum 510.

In some aspects, one or more messages may be restricted to being transmitted via an uplink spectrum 515 or a downlink spectrum 510. For example, downlink signaling such as an SSB (e.g., including a PBCH), a system information block (SIB) message (e.g., SIB1), random access communications (e.g., a Msg. 2 transmission or a Msg. 4 transmission), or downlink control messages (e.g., via a PDCCH) transmitted by the network node 110 may be restricted from transmission via an uplink spectrum 515 and may be limited to transmission via a downlink spectrum 510. Additionally, or alternatively, uplink signaling such as uplink control messages (e.g., via a PUCCH), or random access signaling (e.g., a PRACH message a Msg 3 transmission or a Msg. 5 transmission) may be restricted from transmission via a downlink spectrum 510 and may be limited to transmission by the UE 120 via an uplink spectrum 515.

In some aspects, downlink transmissions via an uplink spectrum 515 or uplink transmissions via a downlink spectrum 510 may be subject to one or more restrictions. For example, downlink transmissions from the network node 110 via the uplink spectrum 515a may cause interference with reception of uplink messages by other network nodes 110 that may be operating in an adjacent band to the uplink spectrum 515a. Additionally, or alternatively, uplink transmissions from the UE 120 via the downlink spectrum 510b may cause interference with reception of downlink messages by other UEs 120 that may be operating in an adjacent band to the downlink spectrum 510b. Accordingly, the network node 110 or the UE 120 may be configured with the one or more restrictions, which may limit interference to other devices operating in adjacent bands. In some examples, the one or more restrictions may include one or more ACLR parameters that may be used when transmitting downlink messages via an uplink spectrum 515 or uplink messages via a downlink spectrum 510.

In some examples, the one or more restrictions may include a reduction in transmission power. For example, the one or more ACLR parameters may configure the network node 110 to reduce a transmission power level when transmitting downlink messages via the downlink slots 520a, 520b, 520c, 520d, 520e, or 520f, or via the special slots 530a or 530b (e.g., the downlink portions 535 of the special slots 530). Additionally, or alternatively, the one or more ACLR parameters may configure the UE 120 to reduce a transmission power level when transmitting uplink messages via the downlink spectrum 510b. In some examples, the ACLR parameters may indicate a value (e.g., X, which may be in units of decibels) by which to decrease the transmission power level relative to a baseline power level.

Accordingly, interference caused by the downlink messages via the uplink spectrum 515a or the uplink messages via the downlink spectrum 510b to devices operating in adjacent bands may be reduced by using the reduced transmit power.

As indicated above, FIG. 5 is provided as an example. Other examples may differ from what is described with regard to FIG. 5.

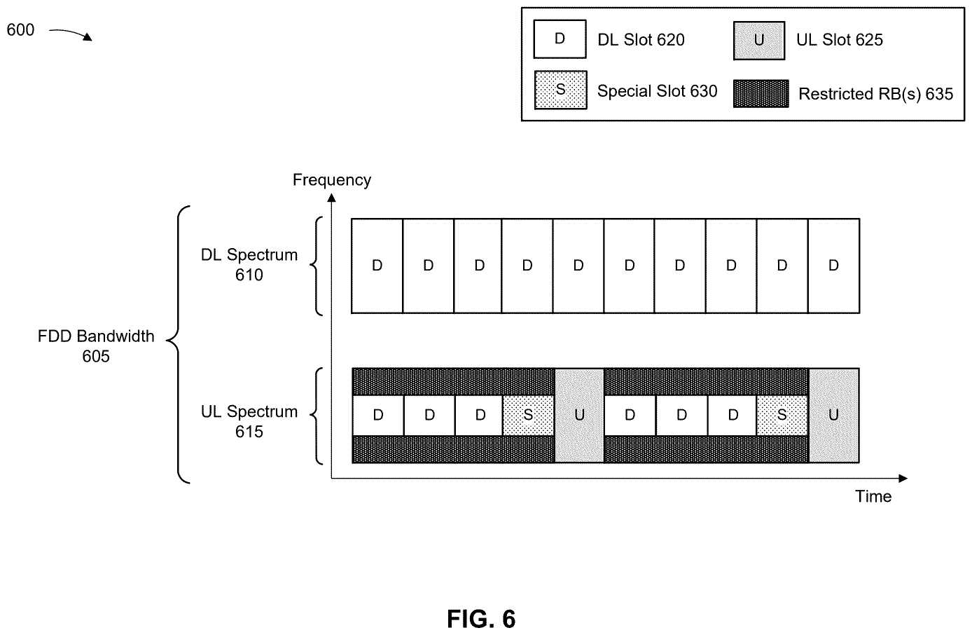

FIG. 6 is a diagram illustrating an example 600 of restrictions for TDD for spectrums configured for FDD. For example, the example 600 illustrates an FDD bandwidth 605, which may be example of a bandwidth (e.g., a bandwidth 505, a carrier bandwidth) allocated for communications associated with a cell. In some examples, the FDD bandwidth 605 may be configured for communications between a network node 110 and a UE 120.

The FDD bandwidth 605 may include a downlink spectrum 610 and an uplink spectrum 615. In some aspects, the uplink spectrum 615 may be configured to support TDD. For example, the uplink spectrum 615 may include one or more downlink slots 620 in addition to one or more uplink slots 625. Additionally, or alternatively, the uplink spectrum 615 may include one or more special slots 630, as described herein. In some aspects, uplink spectrum 615 may be configured to support TDD in accordance with a configuration transmitted by the network node 110 to the UE 120. For example, the configuration may indicate a TDD pattern for the uplink spectrum 615, and the TDD pattern may include the one or more downlink slots 620, the one or more uplink slots 625, or the one or more special slots 630 for the uplink spectrum 615. For example, the TDD pattern may be a “DDDSU” pattern, which may correspond to the pattern shown in the example 600. However, different TDD patterns may be used having a different quantity or a different order associated with the one or more downlink slots 620, the one or more uplink slots 625, or the one or more special slots 630.

In some aspects, downlink transmissions via the uplink spectrum 615 or uplink may be subject to one or more restrictions. For example, downlink transmissions from the network node 110 via the uplink spectrum 615 may cause interference with reception of uplink signaling by other network nodes 110 that may be operating in an adjacent band to the uplink spectrum 615. Accordingly, the network node 110 may be configured with the one or more restrictions (e.g., associated with one or more ACLR parameters), which may limit interference to other devices operating in adjacent bands.

In some examples, the one or more restrictions may include limiting downlink transmissions via the uplink spectrum 615 to a center portion of the uplink spectrum 615. For example, the one or more restrictions (e.g., via one or more ACLR parameters) may limit the downlink transmissions via the uplink spectrum 615 to one or more center RBs of the uplink spectrum 615. Accordingly, the uplink spectrum 615 may include one or more restricted RBs 635, which may be positioned at an upper end (e.g., in the frequency domain) of the uplink spectrum 615, at a lower end (e.g., in the frequency domain) of the uplink spectrum 615, or at both an upper end and a lower end of the uplink spectrum 615, as illustrated in FIG. 6. In some aspects, the one or more restrictions configured to the network node 110 may indicate a quantity Y of center RBs for which downlink transmissions via the uplink spectrum 615 are allowed (e.g., via downlink slots 620 or special slots 630), while other RBs are restricted.

Accordingly, interference caused by downlink messages transmitted from the network node 110 via the uplink spectrum 615 to other network nodes 110 operating in adjacent bands to the uplink spectrum 615 may be reduced by limiting the transmission of the downlink messages to center RBs of the uplink spectrum 615.

As indicated above, FIG. 6 is provided as an example. Other examples may differ from what is described with regard to FIG. 6.

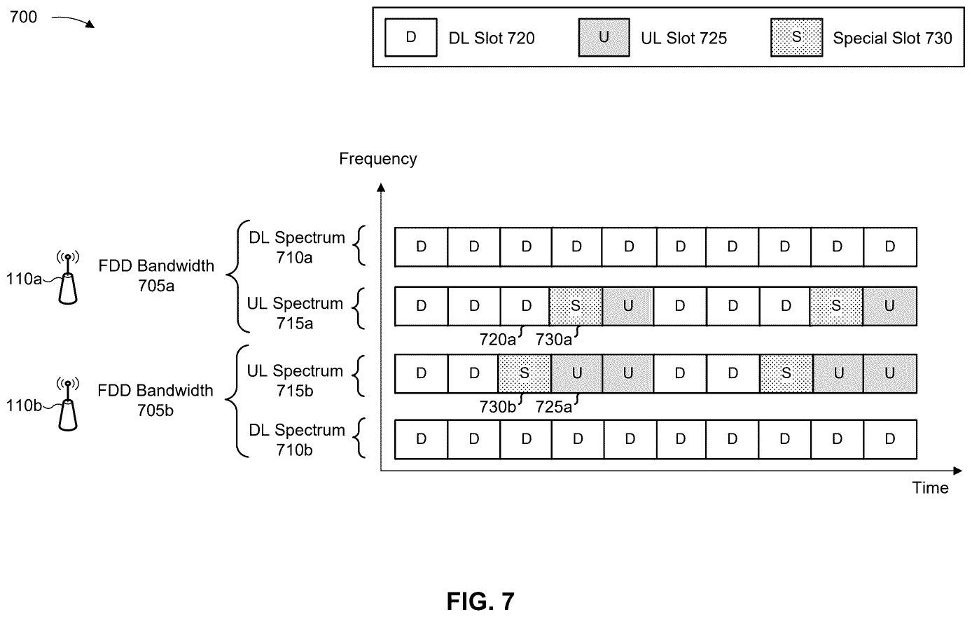

FIG. 7 is a diagram illustrating an example 700 of restrictions for TDD for spectrums configured for FDD. For example, the example 700 illustrates an FDD bandwidth 705a and an FDD bandwidth 705b, which may be examples of a bandwidth (e.g., a carrier bandwidth) allocated for communications associated with a cell. In some examples, the FDD bandwidth 705a may be associated with a network node 110a and configured for communications between the network node 110a and one or more UEs 120, and the FDD bandwidth 705b may be associated with a network node 110b and configured for communications between the network node 110b and one or more UEs 120.

The FDD bandwidth 705a may include a downlink spectrum 710a and an uplink spectrum 715a. Similarly, the FDD bandwidth 705b may include a downlink spectrum 710b and an uplink spectrum 715b. In some aspects, the uplink spectrum 715a and the uplink spectrum 715b may each be configured to support TDD. For example, the uplink spectrum 715a and the uplink spectrum 715b may each include one or more downlink slots 720, one or more uplink slots 725, and one or more special slots 725, as described herein.

In some aspects, the uplink spectrum 715a may be configured in accordance with a first TDD pattern. For example, the network node 110a may transmit, to one or more UEs 120, a first configuration indicating the first TDD pattern for the uplink spectrum 715a, and the TDD pattern may indicate the one or more downlink slots 720, the one or more uplink slots 725, or the one or more special slots 730 for the uplink spectrum 715a. Similarly, the uplink spectrum 715b may be configured in accordance with a second TDD pattern. For example, the network node 110b may transmit, to one or more UEs 120, a second configuration indicating the second TDD pattern for the uplink spectrum 715b, and the TDD pattern may indicate the one or more downlink slots 720, the one or more uplink slots 725, or the one or more special slots 730 for the uplink spectrum 715b.

In some cases, the first TDD pattern and the second TDD pattern may be different. For example, the uplink spectrum 715a may be associated with a “DDDSU” pattern, and the uplink spectrum 715b may be associated with a “DDSUU” pattern. However, these patterns are provided as an example, and different TDD patterns may be used. Additionally, or alternatively, the uplink spectrum 715a and the uplink spectrum 715b may be adjacent in frequencies. For example, the uplink spectrum 715a may be configured for a frequency band between 1920 MHz and 1980 MHz, and the uplink spectrum 715 b may be configured for a frequency band between 1850 MHz and 1910 MHz. Accordingly, in some cases, downlink transmissions transmitted via the uplink spectrum 715a or the uplink spectrum 715b may cause interference for the network node 110a or the network node 110b.

For example, downlink messages transmitted by the network node 110a via a downlink slot 720a or a special slot 730a may interfere with reception by the network node 110b of uplink messages via a special slot 730b or an uplink slot 725a (e.g., in cases where the uplink spectrum 715a and the uplink spectrum 715b are adjacent in frequency). Accordingly, in some aspects, one or more restrictions may by applied for downlink messages transmitted via one or more downlink slots 720 or special slots 730 of the uplink spectrum 715a (e.g., via the downlink slot 720a or the special slot 730a). For example, the network node 110a may be configured with one or more ACLR parameters to limit interference to network node 110b when transmitting downlink messages via the uplink spectrum 715a.

In some examples, the one or more restrictions may include power limitations or restriction to center RBs, as described herein, or restricting transmissions via RBs at one end of the uplink spectrum 715a (e.g., a lower end in the frequency domain). For example, the one or more restrictions may include applying one or more ACLR parameters for transmissions. In some aspects, the one or more restrictions may be applied in accordance with the network node 110a and the network node 110b using different TDD patterns.

Additionally, or alternatively, one or more techniques may be implemented at the network node 110a or the network node 110b to mitigate interference, including using different time slot allocations (e.g., TDD patterns) that may mitigate interference, using cell clustering configured to mitigate interference (e.g., by grouping cells that experience interference, and grouped cells may be configured to use a same TDD pattern), controlling access to the network nodes 110a and 110b to mitigate interference (e.g., reducing a quantity of connected UEs 120), coordinating beamforming between the network node 110a and the network node 110b (e.g., configuring a direction of beams, such as downlink beams, to avoid interference to the other network node 110), or implementing advanced receivers that may be able to detect uplink messages even when interference is present.

Accordingly, by implementing the techniques described herein, interference caused by downlink messages transmitted from the network node 110a via the uplink spectrum 715a to the network node 110b operating using the uplink spectrum 715b may be reduced.

As indicated above, FIG. 7 is provided as an example. Other examples may differ from what is described with regard to FIG. 7.

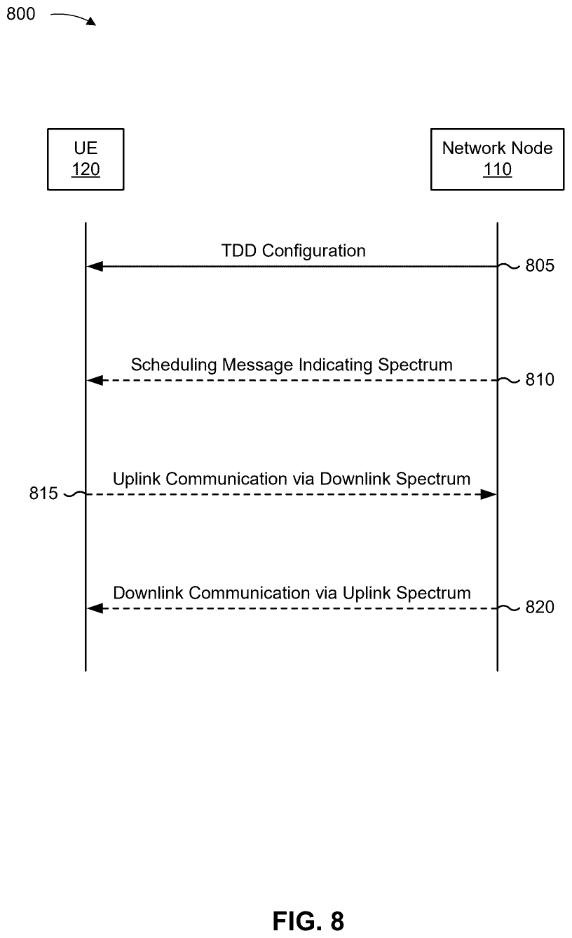

FIG. 8 is a diagram illustrating an example 800 that supports configuring TDD for an FDD spectrum. The example 800 illustrates communications between a UE 120 and a network node 110.

As shown by reference number 805, the network node 110 may transmit, and the UE 120 may receive, a configuration indicating a TDD pattern associated with a spectrum configured for FDD. In some aspects, the TDD pattern may include one or more uplink slots and one or more downlink slots. Additionally, or alternatively, the TDD pattern may include one or roe special slots, as described herein. In some examples, the spectrum may be an uplink spectrum of a bandwidth associated with the network node 110 configured for FDD. Additionally, or alternatively, the spectrum may be a downlink spectrum of a bandwidth associated with the network node 110 configured for FDD.

As shown by reference number 810, the network node 110 may transmit, and the UE 120, may receive, a scheduling message that schedules one or more uplink messages or downlink message. In some examples, the scheduling message may indicate whether the uplink message or downlink messages are to be transmitted via an uplink spectrum or a downlink spectrum. For example, the network node 110 may transmit a DCI message that schedules (e.g., dynamically schedules) a PDSCH message for transmission from the network node 110 to the UE 120 or a PUSCH message for transmission from the UE 120 to the network node 110. In some aspects, the DCI message may indicate (e.g., via at least one bit) whether the PDSCH message or the PUSCH message scheduled by the DCI message is to be transmitted via an uplink spectrum or a downlink spectrum. Additionally, or alternatively, the network node 110 may transmit an RRC message that configures one or more PDSCH messages (e.g., for semi-persistent scheduling) or one or more PUSCH messages (e.g., for configured-grant scheduling), and the RRC message may indicate (e.g., via at least one bit) whether the one or more PDSCH messages or the one or more PUSCH messages configured by the RRC message are to be transmitted via the uplink spectrum or the downlink spectrum.

As shown by reference number 815, the UE 120 may transmit, and the network node 110 may receive, uplink communications (e.g., one or more uplink messages) via the downlink spectrum in accordance with the TDD pattern. Additionally, or alternatively, as shown by reference number 820, the network node 110 may transmit, and the UE 120 may receive, downlink communications (e.g., one or more uplink messages) via the uplink spectrum in accordance with the TDD pattern.

In some aspects, the uplink messages transmitted via the downlink spectrum or downlink messages transmitted via the uplink spectrum may be transmitted in accordance with one or more ACLR parameters, may reduce interference to other devices operating in adjacent bands. In some examples, the one or more ACLR parameters may include a power reduction parameter. For example, the one or more ACLR parameters may configure the network node 110 to reduce a transmission power level when transmitting downlink messages via the uplink spectrum. Additionally, or alternatively, the one or more ACLR parameters may configure the UE 120 to reduce a transmission power level when transmitting uplink messages via the downlink spectrum. In some examples, the ACLR parameters may indicate a value (e.g., X, which may be in units of decibels) for the power reduction parameter by which to decrease the transmission power level.

Additionally, or alternatively, the one or more ACLR parameters may include a frequency restriction parameter, which may limit transmissions to a portion of the spectrum. For example, downlink transmissions by the network node 110 via the uplink spectrum may be limited to one or more center RBs of the uplink spectrum. Additionally, or alternatively, uplink transmissions by the UE 120 via the downlink spectrum may be limited to one or more center RBs of the downlink spectrum. In some aspects, the one or more ACLR parameters may include a value (e.g., Y) for the frequency restriction parameter, which may correspond to a quantity of center RBs for which transmissions via the spectrum are allowed, while other RBs at an upper end or a lower end of the spectrum are restricted.

Accordingly, the configuration may enable the UE 120 to transmit uplink messages via the downlink spectrum or the network node 110 to transmit downlink messages via the uplink spectrum, which may increase transmissions throughput and support an increased utilization of communication resources relative to FDD-only communications. Additionally, interference caused by downlink messages transmitted from the network node 110 via the uplink spectrum or uplink messages transmitted from the UE via the downlink spectrum may be reduced in accordance with the ACLR parameters.

As indicated above, FIG. 8 is provided as an example. Other examples may differ from what is described with respect to FIG. 8.

FIG. 9 is a diagram illustrating an example process 900 performed, for example, at a UE or an apparatus of a UE. Example process 900 is an example where the apparatus or the UE (e.g., UE 120) performs operations associated with TDD for spectrum configured for FDD.

As shown in FIG. 9, in some aspects, process 900 may include receiving, from a network node, a configuration indicating a TDD pattern associated with a spectrum configured for FDD, wherein the TDD pattern includes one or more uplink slots and one or more downlink slots (block 910). For example, the UE (e.g., using reception component 1102 or communication manager 1106, depicted in FIG. 11) may receive, from a network node, a configuration indicating a TDD pattern associated with a spectrum configured for FDD, wherein the TDD pattern includes one or more uplink slots and one or more downlink slots, as described above.

As further shown in FIG. 9, in some aspects, process 900 may include communicating with the network node in the spectrum configured for FDD according to the TDD pattern and according to one or more ACLR parameters (block 920). For example, the UE (e.g., using reception component 1102, transmission component 1104, or communication manager 1106, depicted in FIG. 11) may communicate with the network node in the spectrum configured for FDD according to the TDD pattern and according to one or more ACLR parameters, as described above.

Process 900 may include additional aspects, such as any single aspect or any combination of aspects described below or in connection with one or more other processes described elsewhere herein.

In a first aspect, the spectrum associated with the TDD pattern is an uplink spectrum of an FDD band.

In a second aspect, communicating with the network node comprises receiving, from the network node in the uplink spectrum and via the one or more downlink slots, a downlink message according to the TDD pattern and according to the one or more ACLR parameters.

In a third aspect, receiving the downlink message according to the one or more ACLR parameters comprises receiving the downlink message associated with a power level that is limited in accordance with the one or more ACLR parameters based at least in part on the downlink message being transmitted via the uplink spectrum.

In a fourth aspect, receiving the downlink message according to the one or more ACLR parameters comprises receiving the downlink message via a portion of a set of multiple resource blocks of the uplink spectrum, the portion of the set of multiple resource blocks excluding one or more resource blocks positioned at an upper end of the uplink spectrum and one or more resource blocks positioned at a lower end of the uplink spectrum.

In a fifth aspect, the receiving the downlink message according to the one or more ACLR parameters is based at least in part on the TDD pattern being different from a second TDD pattern associated with a second network node.

In a sixth aspect, the spectrum associated with the TDD pattern is a downlink spectrum of an FDD band.

In a seventh aspect, communicating with the network node comprises transmitting, to the network node in the downlink spectrum and via the one or more uplink slots, an uplink message according to the TDD pattern and according to the one or more ACLR parameters.

In an eighth aspect, receiving the configuration is based at least in part on an at least one of an amount of downlink traffic satisfying a first threshold, or an amount of uplink traffic satisfying a second threshold.

In a ninth aspect, process 900 includes receiving, from the network node, downlink control information that schedules a transmission of a data message, wherein the downlink control information includes at least one bit indicating whether the transmission is to be transmitted via the one or more uplink slots or the one or more downlink slots.

In a tenth aspect, process 900 includes receiving, from the network node, an RRC message that schedules one or more data transmissions, wherein the RRC message includes at least one bit indicating whether the one or more data transmissions are to be transmitted via the one or more uplink slots or the one or more downlink slots.

In an eleventh aspect, the TDD pattern includes a special slot, the special slot comprising a downlink portion, an uplink portion, and a guard period positioned between the downlink portion and the uplink portion.

In a twelfth aspect, the special slot is positioned between a downlink slot of the one or more downlink slots and an uplink slot of the one or more uplink slots.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node. Example process 1000 is an example where the apparatus or the network node (e.g., network node 110) performs operations associated with TDD for spectrum configured for FDD.

As shown in FIG. 10, in some aspects, process 1000 may include transmitting, to a UE, a configuration indicating a TDD pattern associated with a spectrum configured for FDD, wherein the TDD pattern includes one or more uplink slots and one or more downlink slots (block 1010). For example, the network node (e.g., using transmission component 1204 or communication manager 1206, depicted in FIG. 12) may transmit, to a UE, a configuration indicating a TDD pattern associated with a spectrum configured for FDD, wherein the TDD pattern includes one or more uplink slots and one or more downlink slots, as described above.

As further shown in FIG. 10, in some aspects, process 1000 may include communicating with the UE in the spectrum configured for FDD according to the TDD pattern and according to one or more ACLR parameters (block 1020). For example, the network node (e.g., using reception component 1202, transmission component 1204, or communication manager 1206, depicted in FIG. 12) may communicate with the UE in the spectrum configured for FDD according to the TDD pattern and according to one or more ACLR parameters, as described above.

Process 1000 may include additional aspects, such as any single aspect or any combination of aspects described below or in connection with one or more other processes described elsewhere herein.

In a first aspect, the spectrum associated with the TDD pattern is an uplink spectrum of an FDD band.

In a second aspect, communicating with the UE comprises transmitting, to the UE in the uplink spectrum and via the one or more downlink slots, a downlink message according to the TDD pattern and according to the one or more ACLR parameters.

In a third aspect, transmitting the downlink message according to the one or more ACLR parameters comprises transmitting the downlink message with a power level that is limited in accordance with the one or more ACLR parameters based at least in part on the downlink message being transmitted via the uplink spectrum.

In a fourth aspect, transmitting the downlink message according to the one or more ACLR parameters comprises transmitting the downlink message via a portion of a set of multiple resource blocks of the uplink spectrum, the portion of the set of multiple resource blocks excluding one or more resource blocks positioned at an upper end of the uplink spectrum and one or more resource blocks positioned at a lower end of the uplink spectrum.

In a fifth aspect, the transmitting the downlink message according to the one or more ACLR parameters is based at least in part on the TDD pattern being different from a second TDD pattern associated with a second network node.

In a sixth aspect, the spectrum associated with the TDD pattern is a downlink spectrum of an FDD band.

In a seventh aspect, communicating with the network node comprises receiving, from the UE in the downlink spectrum and via the one or more uplink slots, an uplink message according to the TDD pattern and according to the one or more ACLR parameters.

In an eighth aspect, transmitting the configuration is based at least in part on an at least one of an amount of downlink traffic satisfying a first threshold, or an amount of uplink traffic satisfying a second threshold.

In a ninth aspect, process 1000 includes transmitting, to the UE, downlink control information that schedules a transmission of a data message, wherein the downlink control information includes at least one bit indicating whether the transmission is to be transmitted via the one or more uplink slots or the one or more downlink slots.

In a tenth aspect, process 1000 includes transmitting, to the UE, an RRC message that schedules one or more data transmissions, wherein the RRC message includes at least one bit indicating whether the one or more data transmissions are to be transmitted via the one or more uplink slots or the one or more downlink slots.

In an eleventh aspect, the TDD pattern includes a special slot, the special slot comprising a downlink portion, an uplink portion, and a guard period positioned between the downlink portion and the uplink portion.

In a twelfth aspect, the special slot is positioned between a downlink slot of the one or more downlink slots and an uplink slot of the one or more uplink slots.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 4-8. Additionally, or alternatively, the apparatus 1100 may be configured to perform one or more processes described herein, such as process 900 of FIG. 9. In some aspects, the apparatus 1100 or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The reception component 1102 may receive, from a network node, a configuration indicating a TDD pattern associated with a spectrum configured for FDD, wherein the TDD pattern includes one or more uplink slots and one or more downlink slots. The reception component 1102 or the transmission component 1104 may communicate with the network node in the spectrum configured for FDD according to the TDD pattern and according to one or more ACLR parameters.

The transmission component 1104 may transmit, to the network node in the downlink spectrum and via the one or more uplink slots, an uplink message according to the TDD pattern and according to the one or more ACLR parameters.

The reception component 1102 may receive, from the network node, downlink control information that schedules a transmission of a data message, wherein the downlink control information includes at least one bit indicating whether the transmission is to be transmitted via the one or more uplink slots or the one or more downlink slots.

The reception component 1102 may receive, from the network node, an RRC message that schedules one or more data transmissions, wherein the RRC message includes at least one bit indicating whether the one or more data transmissions are to be transmitted via the one or more uplink slots or the one or more downlink slots.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network node, or a network node may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 4-8. Additionally, or alternatively, the apparatus 1200 may be configured to perform one or more processes described herein, such as process 1000 of FIG. 10. In some aspects, the apparatus 1200 or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 or the transmission component 1204 may include or may be included in a network interface. The network interface may be configured to obtain or output signals for the apparatus 1200 via one or more communications links, such as a backhaul link, a midhaul link, or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The transmission component 1204 may transmit, to a UE, a configuration indicating a TDD pattern associated with a spectrum configured for FDD, wherein the TDD pattern includes one or more uplink slots and one or more downlink slots. The reception component 1202 or the transmission component 1204 may communicate with the UE in the spectrum configured for FDD according to the TDD pattern and according to one or more ACLR parameters.

The reception component 1202 may receive, from the UE in the downlink spectrum and via the one or more uplink slots, an uplink message according to the TDD pattern and according to the one or more ACLR parameters.

The transmission component 1204 may transmit, to the UE, downlink control information that schedules a transmission of a data message, wherein the downlink control information includes at least one bit indicating whether the transmission is to be transmitted via the one or more uplink slots or the one or more downlink slots.

The transmission component 1204 may transmit, to the UE, an RRC message that schedules one or more data transmissions, wherein the RRC message includes at least one bit indicating whether the one or more data transmissions are to be transmitted via the one or more uplink slots or the one or more downlink slots.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a UE, comprising: receiving, from a network node, a configuration indicating a TDD pattern associated with a spectrum configured for FDD, wherein the TDD pattern includes one or more uplink slots and one or more downlink slots; and communicating with the network node in the spectrum configured for FDD according to the TDD pattern and according to one or more ACLR parameters.
Aspect 2: The method of Aspect 1, wherein the spectrum associated with the TDD pattern is an uplink spectrum of an FDD band.
Aspect 3: The method of Aspect 2, wherein communicating with the network node comprises: receiving, from the network node in the uplink spectrum and via the one or more downlink slots, a downlink message according to the TDD pattern and according to the one or more ACLR parameters.
Aspect 4: The method of Aspect 3, wherein receiving the downlink message according to the one or more ACLR parameters comprises receiving the downlink message associated with a power level that is limited in accordance with the one or more ACLR parameters based at least in part on the downlink message being transmitted via the uplink spectrum.
Aspect 5: The method of any of Aspects 3-4, wherein receiving the downlink message according to the one or more ACLR parameters comprises receiving the downlink message via a portion of a set of multiple resource blocks of the uplink spectrum, the portion of the set of multiple resource blocks excluding one or more resource blocks positioned at an upper end of the uplink spectrum and one or more resource blocks positioned at a lower end of the uplink spectrum.
Aspect 6: The method of any of Aspects 3-5, wherein the receiving the downlink message according to the one or more ACLR parameters is based at least in part on the TDD pattern being different from a second TDD pattern associated with a second network node.
Aspect 7: The method of any of Aspects 1-6, wherein the spectrum associated with the TDD pattern is a downlink spectrum of an FDD band.
Aspect 8: The method of Aspect 7, wherein communicating with the network node comprises: transmitting, to the network node in the downlink spectrum and via the one or more uplink slots, an uplink message according to the TDD pattern and according to the one or more ACLR parameters.
Aspect 9: The method of any of Aspects 1-8, wherein receiving the configuration is based at least in part on an at least one of an amount of downlink traffic satisfying a first threshold, or an amount of uplink traffic satisfying a second threshold.
Aspect 10: The method of any of Aspects 1-9, further comprising: receiving, from the network node, downlink control information that schedules a transmission of a data message, wherein the downlink control information includes at least one bit indicating whether the transmission is to be transmitted via the one or more uplink slots or the one or more downlink slots.
Aspect 11: The method of any of Aspects 1-10, further comprising: receiving, from the network node, an RRC message that schedules one or more data transmissions, wherein the RRC message includes at least one bit indicating whether the one or more data transmissions are to be transmitted via the one or more uplink slots or the one or more downlink slots.
Aspect 12: The method of any of Aspects 1-11, wherein the TDD pattern includes a special slot, the special slot comprising a downlink portion, an uplink portion, and a guard period positioned between the downlink portion and the uplink portion.
Aspect 13: The method of Aspect 12, wherein the special slot is positioned between a downlink slot of the one or more downlink slots and an uplink slot of the one or more uplink slots.
Aspect 14: A method of wireless communication performed by a network node, comprising: transmitting, to a UE, a configuration indicating a TDD pattern associated with a spectrum configured for FDD, wherein the TDD pattern includes one or more uplink slots and one or more downlink slots; and communicating with the UE in the spectrum configured for FDD according to the TDD pattern and according to one or more ACLR parameters.
Aspect 15: The method of Aspect 14, wherein the spectrum associated with the TDD pattern is an uplink spectrum of an FDD band.
Aspect 16: The method of Aspect 15, wherein communicating with the UE comprises: transmitting, to the UE in the uplink spectrum and via the one or more downlink slots, a downlink message according to the TDD pattern and according to the one or more ACLR parameters.
Aspect 17: The method of Aspect 16, wherein transmitting the downlink message according to the one or more ACLR parameters comprises transmitting the downlink message with a power level that is limited in accordance with the one or more ACLR parameters based at least in part on the downlink message being transmitted via the uplink spectrum.
Aspect 18: The method of any of Aspects 16-17, wherein transmitting the downlink message according to the one or more ACLR parameters comprises transmitting the downlink message via a portion of a set of multiple resource blocks of the uplink spectrum, the portion of the set of multiple resource blocks excluding one or more resource blocks positioned at an upper end of the uplink spectrum and one or more resource blocks positioned at a lower end of the uplink spectrum.
Aspect 19: The method of any of Aspects 16-18, wherein the transmitting the downlink message according to the one or more ACLR parameters is based at least in part on the TDD pattern being different from a second TDD pattern associated with a second network node.
Aspect 20: The method of any of Aspects 14-19, wherein the spectrum associated with the TDD pattern is a downlink spectrum of an FDD band.
Aspect 21: The method of Aspect 20, wherein communicating with the network node comprises: receiving, from the UE in the downlink spectrum and via the one or more uplink slots, an uplink message according to the TDD pattern and according to the one or more ACLR parameters.
Aspect 22: The method of any of Aspects 14-21, wherein transmitting the configuration is based at least in part on an at least one of an amount of downlink traffic satisfying a first threshold, or an amount of uplink traffic satisfying a second threshold.
Aspect 23: The method of any of Aspects 14-22, further comprising: transmitting, to the UE, downlink control information that schedules a transmission of a data message, wherein the downlink control information includes at least one bit indicating whether the transmission is to be transmitted via the one or more uplink slots or the one or more downlink slots.
Aspect 24: The method of any of Aspects 14-23, further comprising: transmitting, to the UE, an RRC message that schedules one or more data transmissions, wherein the RRC message includes at least one bit indicating whether the one or more data transmissions are to be transmitted via the one or more uplink slots or the one or more downlink slots.
Aspect 25: The method of any of Aspects 14-24, wherein the TDD pattern includes a special slot, the special slot comprising a downlink portion, an uplink portion, and a guard period positioned between the downlink portion and the uplink portion.
Aspect 26: The method of Aspect 25, wherein the special slot is positioned between a downlink slot of the one or more downlink slots and an uplink slot of the one or more uplink slots.
Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.
Aspect 28: An apparatus for wireless communication at a device, the apparatus comprising one or more memories and one or more processors coupled to the one or more memories, the one or more processors configured to cause the device to perform the method of one or more of Aspects 1-26.
Aspect 29: An apparatus for wireless communication, the apparatus comprising at least one means for performing the method of one or more of Aspects 1-26.
Aspect 30: A non-transitory computer-readable medium storing code for wireless communication, the code comprising instructions executable by one or more processors to perform the method of one or more of Aspects 1-26.
Aspect 31: A non-transitory computer-readable medium storing a set of instructions for wireless communication, the set of instructions comprising one or more instructions that, when executed by one or more processors of a device, cause the device to perform the method of one or more of Aspects 1-26.
Aspect 32: A device for wireless communication, the device comprising a processing system that includes one or more processors and one or more memories coupled with the one or more processors, the processing system configured to cause the device to perform the method of one or more of Aspects 1-26.
Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.
Aspect 34: A device comprising a processing system that includes one or more processors and one or more code-storing memories coupled with the one or more processors, the processing system configured to cause the device to perform the method of one or more of Aspects 1-26.
Aspect 35: A device comprising a processing system that includes processor circuitry and code-storing memory circuitry, the processing system configured to cause the device to perform the method of one or more of Aspects 1-26.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more code-storing memories coupled with the one or more processors, the processing system configured to cause the UE to:
receive, from a network node, a configuration indicating a time division duplexing (TDD) pattern associated with a spectrum configured for frequency division duplexing (FDD), wherein the TDD pattern includes one or more uplink slots and one or more downlink slots; and
communicate with the network node in the spectrum configured for FDD according to the TDD pattern and according to one or more adjacent channel leakage ratio (ACLR) parameters.

2. The UE of claim 1, wherein the spectrum associated with the TDD pattern is an uplink spectrum of an FDD band.

3. The UE of claim 2, wherein the processing system, to cause the UE to communicate with the network node, is configured to cause the UE to:
receive, from the network node in the uplink spectrum and via the one or more downlink slots, a downlink message according to the TDD pattern and according to the one or more ACLR parameters.

4. The UE of claim 3, wherein the processing system, to cause the UE to receive the downlink message according to the one or more ACLR parameters, is configured to cause the UE to receive the downlink message associated with a power level that is limited in accordance with the one or more ACLR parameters based at least in part on the downlink message being transmitted via the uplink spectrum.

5. The UE of claim 3, wherein the processing system, to cause the UE to receive the downlink message according to the one or more ACLR parameters, is configured to cause the UE to receive the downlink message via a portion of a set of multiple resource blocks of the uplink spectrum, the portion of the set of multiple resource blocks excluding one or more resource blocks positioned at an upper end of the uplink spectrum and one or more resource blocks positioned at a lower end of the uplink spectrum.

6. The UE of claim 3, wherein the reception of the downlink message according to the one or more ACLR parameters is based at least in part on the TDD pattern being different from a second TDD pattern associated with a second network node.

7. The UE of claim 1, wherein the spectrum associated with the TDD pattern is a downlink spectrum of an FDD band.

8. The UE of claim 7, wherein the processing system, to cause the UE to communicate with the network node, is configured to cause the UE to:
transmit, to the network node in the downlink spectrum and via the one or more uplink slots, an uplink message according to the TDD pattern and according to the one or more ACLR parameters.

9. The UE of claim 1, wherein the reception of the configuration is based at least in part on an at least one of an amount of downlink traffic satisfying a first threshold, or an amount of uplink traffic satisfying a second threshold.

10. The UE of claim 1, wherein the processing system is further configured to cause the UE to:
receive, from the network node, downlink control information that schedules a transmission of a data message, wherein the downlink control information includes at least one bit indicating whether the transmission is to be transmitted via the one or more uplink slots or the one or more downlink slots.

11. The UE of claim 1, wherein the processing system is further configured to cause the UE to:
receive, from the network node, a radio resource control (RRC) message that schedules one or more data transmissions, wherein the RRC message includes at least one bit indicating whether the one or more data transmissions are to be transmitted via the one or more uplink slots or the one or more downlink slots.

12. The UE of claim 1, wherein the TDD pattern includes a special slot, the special slot comprising a downlink portion, an uplink portion, and a guard period positioned between the downlink portion and the uplink portion.

13. The UE of claim 12, wherein the special slot is positioned between a downlink slot of the one or more downlink slots and an uplink slot of the one or more uplink slots.

14. A method of wireless communication performed by a user equipment (UE), comprising:
receiving, from a network node, a configuration indicating a time division duplexing (TDD) pattern associated with a spectrum configured for frequency division duplexing (FDD), wherein the TDD pattern includes one or more uplink slots and one or more downlink slots; and
communicating with the network node in the spectrum configured for FDD according to the TDD pattern and according to one or more adjacent channel leakage ratio (ACLR) parameters.

15. The method of claim 14, wherein the spectrum associated with the TDD pattern is an uplink spectrum of an FDD band.

16. The method of claim 15, wherein communicating with the network node comprises:
receiving, from the network node in the uplink spectrum and via the one or more downlink slots, a downlink message according to the TDD pattern and according to the one or more ACLR parameters.

17. The method of claim 16, wherein receiving the downlink message according to the one or more ACLR parameters comprises receiving the downlink message associated with a power level that is limited in accordance with the one or more ACLR parameters based at least in part on the downlink message being transmitted via the uplink spectrum.

18. The method of claim 16, wherein receiving the downlink message according to the one or more ACLR parameters comprises receiving the downlink message via a portion of a set of multiple resource blocks of the uplink spectrum, the portion of the set of multiple resource blocks excluding one or more resource blocks positioned at an upper end of the uplink spectrum and one or more resource blocks positioned at a lower end of the uplink spectrum.

19. The method of claim 16, wherein the receiving the downlink message according to the one or more ACLR parameters is based at least in part on the TDD pattern being different from a second TDD pattern associated with a second network node.

20. A non-transitory computer-readable medium storing a set of instructions for wireless communication, the set of instructions comprising:
one or more instructions that, when executed by one or more processors of a user equipment (UE), cause the UE to:
receive, from a network node, a configuration indicating a time division duplexing (TDD) pattern associated with a spectrum configured for frequency division duplexing (FDD), wherein the TDD pattern includes one or more uplink slots and one or more downlink slots; and
communicate with the network node in the spectrum configured for FDD according to the TDD pattern and according to one or more adjacent channel leakage ratio (ACLR) parameters.
